(19) United States
(12) Patent Application Publication
(10) Pub. No.: US 2025/0303619 A1
(43) Pub. Date: Oct. 2, 2025

(54) SYSTEM AND METHOD FOR FORMING INFILL STRUCTURE

(71) Applicant: NIKE, Inc., Beaverton, OR (US)

(72) Inventors: Viviane Labelle, Portland, OR (US); Michael J. Lombardi, JR., Hillsboro, OR (US); Nadia M. Panian, Beaverton, OR (US)

(73) Assignee: NIKE, Inc., Beaverton, OR (US)

(21) Appl. No.: 19/089,478

(22) Filed: Mar. 25, 2025

Related U.S. Application Data
(60) Provisional application No. 63/569,926, filed on Mar. 26, 2024.

(51) Int. Cl. B29C 43/56; B29C 43/36; B29C 43/52; B29K 105/04; B29L 31/50

(52) U.S. Cl. CPC B29C 43/56; B29C 43/52; B29C 2043/3644; B29C 2043/562; B29K 2105/04; B29L 2031/50

(57) ABSTRACT

A method includes forming a base mold including a base surface, a mold surface formed on an opposite side of the base mold, and a plurality of vacuum ports extending between the base mold and the mold surface and positioning an infill material on the base mold, the infill material including a first surface in contact with the mold surface and a second surface formed on an opposite side of the infill material than the first surface. The method also includes applying a vacuum through the plurality of vacuum ports and to the first surface of the infill material to draw the infill material into contact with the mold surface and inserting the infill material into an interior void of a bladder.

### CROSS REFERENCE TO RELATED APPLICATIONS

This application claims priority under 35 U.S.C. § 119(e) to U.S. Provisional Application No. 63/569,926, filed on Mar. 26, 2024. The disclosure of this prior application is considered part of the disclosure of this application and is hereby incorporated by reference in its entirety.

### FIELD

The present disclosure relates generally to a system and method for forming an infill structure for an article of footwear and/or an article of apparel.

### BACKGROUND

This section provides background information related to the present disclosure and is not necessarily prior art.

Bladders or airbags are used in articles of footwear and apparel to provide cushioning and other performance characteristics during use. Such bladders typically include one or more polymeric films forming an outer layer of the bladder and defining an interior chamber that contains a compressible material, such as a fluid, an elastomeric material, and/or a tensile structure. The fluid and/or elastomeric material provide the bladder with the ability to absorb and cushion forces applied thereto while the tensile member helps maintain a desired shape of the bladder in a relaxed state.

In articles of footwear, bladders are traditionally concealed within a sole structure of the article of footwear to provide cushioning and responsiveness to a wearer during use. Such bladders may be contained within a midsole of the article of footwear and, as a result, are hidden from view. Alternatively, a midsole may include one or more openings where the bladder is visible at a sidewall of the sole structure. Such openings may be so large, in fact, that the bladder forms a majority of a thickness of the sole structure. In such a configuration, a sidewall of the bladder may extend between and join an upper of the article of footwear and a ground-contacting surface of the article of footwear.

Regardless of the particular structure of the bladder and its relationship to other components of the sole structure, the shape, color, and overall appearance of the bladder are typically designed to complement the surrounding structure of the article of footwear and/or the article of apparel to provide the article of footwear and/or the article of apparel with a desired appearance.

### DRAWINGS

The drawings described herein are for illustrative purposes only of selected configurations and not all possible implementations, and are not intended to limit the scope of the present disclosure.

FIG. 1 is an exploded perspective view of an example of a base mold of a mold system according to the present disclosure with a molded infill;

FIG. 2A is a schematic of the base mold of FIG. 1 fluidly coupled to a vacuum device and an example of an infill material according to the present disclosure;

FIG. 2B is a schematic view of the base mold and the infill material of FIG. 2A with the vacuum device applying a negative pressure according to the present disclosure;

FIG. 3 is an exploded top perspective view of another example of a base mold for the mold system according to the present disclosure with a molded infill;

FIG. 4 is a top perspective view of another example of a base mold for the mold system;

FIG. 5 is a cross-sectional schematic view of the base mold of FIG. 3 with the molded infill and the vacuum device applying negative pressure;

FIG. 6A is a cross-sectional view of another example of a mold system according to the present disclosure with an infill material disposed between a flexible sheet and a base mold on a vacuum surface;

FIG. 6B is a cross-sectional view of the mold system of FIG. 6A with the infill material compressed between the flexible sheet and the base mold, where the vacuum device is applying a negative pressure and the flexible sheet is applying a positive pressure;

FIG. 7 is an exploded perspective view of another example of a mold system according to the present disclosure, the mold system including the base mold, the infill material, and a top mold;

FIG. 8 is a schematic of the mold system of FIG. 7, where the top mold is applying a positive pressure to the infill material and the vacuum device is applying a negative pressure to the base mold and the infill material;

FIG. 9 is a side perspective view of an infill according to the present disclosure;

FIG. 10 is a top perspective view of a device forming the infill of FIG. 9 according to the present disclosure;

FIG. 11 is a side elevational view of the infill of FIG. 9;

FIG. 12 is a top plan view of the infill of FIG. 9;

FIG. 13A is a side elevational view of an example of an article of footwear including a molded infill according to the present disclosure, the molded infill in a relaxed state;

FIG. 13B is a side elevational view of the article of footwear including the molded infill of FIG. 13A in a contracted state;

FIG. 14A is a side perspective view of another example of an article of footwear including a molded infill according to the present disclosure, the molded infill in a relaxed state; and

FIG. 14B is a side perspective view of the article of footwear including the molded infill of FIG. 14A in a contracted state.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (, “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In one configuration, a method includes forming a base mold including a base surface, a mold surface formed on an opposite side of the base mold, and a plurality of vacuum ports extending between the base mold and the mold surface and positioning an infill material on the base mold, the infill material including a first surface in contact with the mold surface and a second surface formed on an opposite side of the infill material than the first surface. The method also includes applying a vacuum through the plurality of vacuum ports and to the first surface of the infill material to draw the infill material into contact with the mold surface and inserting the infill material into an interior void of a bladder.

The method may include one or more of the following optional steps. For example, the method may include providing a top mold including a mating surface that mates with the mold surface. In this configuration, the top mold may be compressed onto the second surface of the infill material.

A flexible sheet may be located over the base mold and the infill material. A positive pressure may be applied along the second surface by compressing the flexible sheet along the second surface via the applied vacuum. Applying a vacuum may include positioning the base mold and the flexible sheet along a vacuum surface and applying a negative pressure to the flexible sheet via vacuum ports of the vacuum surface.

In one configuration, heat may be applied to the base mold and/or the infill material.

Forming a base mold may include providing the mold surface with a series of peaks and recesses. Additionally or alternatively, a positive pressure may be applied along the second surface of the infill material to form a molded infill.

In another configuration, a method is provided and includes forming a base mold including a base surface and a mold surface formed on an opposite side of the base mold than the base surface and positioning an infill material on the base mold, the infill material including a first surface in contact with the mold surface and a second surface formed on an opposite side of the infill material than the first surface. The method also includes drawing the infill material into contact with the mold surface of the base mold to shape the infill material into a shape of the mold surface and form an infill and inserting the infill into an interior void of a bladder.

The method may include one or more of the following optional steps. For example, the method may include applying a positive pressure along the second surface of the infill material to form the infill. A top mold may be provided and may include a mating surface, the mating surface contacting the second surface of the infill material. Providing the top mold may include forming a surface pattern along the mating surface, the surface pattern of the mating surface nesting with a surface pattern of the mold surface. Applying a positive pressure along the second surface may include compressing the top mold onto the second surface of the infill material.

In one configuration, a flexible sheet may be disposed over the base mold and the infill material. Drawing the infill material into contact with the mold surface may include applying a negative pressure to the first surface of the infill material. In this configuration, a positive pressure may be applied along the second surface of the infill material.

Heat may be applied to the base mold and/or the infill material. The infill may be incorporated into an article of footwear or an article of apparel.

The details of one or more implementations of the disclosure are set forth in the accompanying drawings and the description below. Other aspects, features, and advantages will be apparent from the description, the drawings, and the claims.

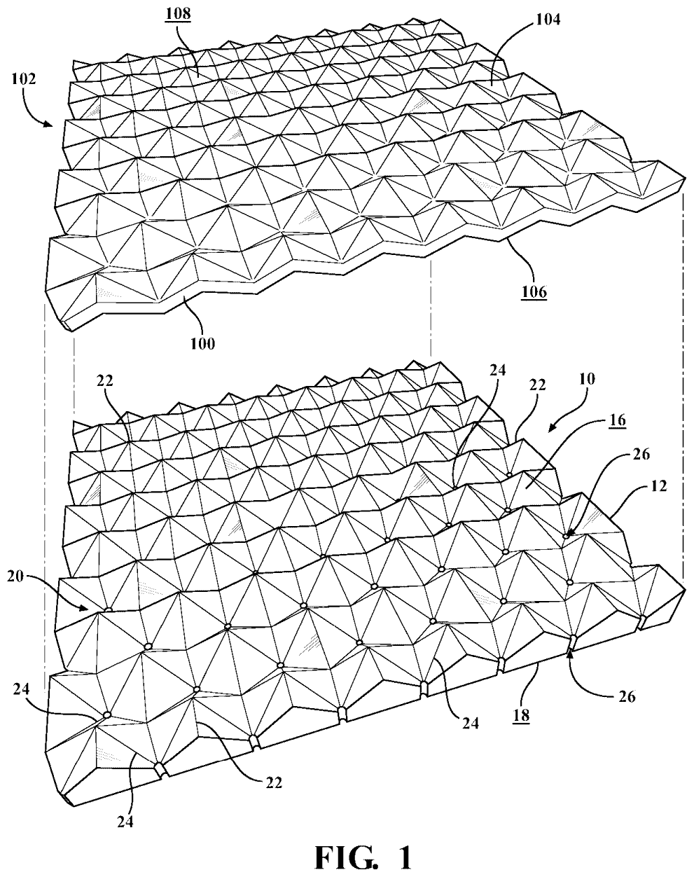

With reference to FIGS. 1-5, an example mold system 10 for molding an infill material 100 for an infill 102 having a textured exterior surface 104 is provided. The mold system 10 includes a base mold 12 that includes a mold surface 16 formed on a first side of the base mold 12 and a base surface 18 formed on an opposite side of the base mold 12 than the mold surface 16. The base surface 18 of the base mold 12 has a substantially flat profile as compared to the mold surface 16. The mold surface 16 may define a textured profile including a desired surface pattern 20 to be formed on an exterior surface of the infill 102. As depicted in FIG. 1, the surface pattern 20 includes peaks 22 and recesses 24 with vacuum ports 26 defined therein. While the recesses 24 generally refer to the lowest portion of the mold surface 16 relative to the peaks 22, the recesses 24 may also refer to potential folds or other crevices along the mold surface 16, which may at least in part define the surface pattern 20. The surface pattern 20 may include a plurality of structural geometries cooperating to define the plurality of peaks 22 and the recesses 24 along the mold surface 16. The surface pattern 20 may have a generally diamond, egg-crate, or pyramid pattern to create the textured exterior surface 104 of the infill 102, described below. Optionally, alternate shapes and configurations of the surface pattern 20 are contemplated.

The base mold 12 also includes the plurality of vacuum ports 26 extending through a thickness T₁₂ of the base mold 12 from the base surface 18 to the mold surface 16. Thus, a negative pressure P_{N} provided to the base mold 12 is communicated through the vacuum ports 26 to the mold surface 16. For example, the vacuum ports 26 may extend through the thickness T₁₂ of the base mold 12 and generally open at the recesses 24 to assist in providing the negative pressure P_{N} along the mold surface 16 of the base mold 12. Additionally or alternatively, the vacuum ports 26 may also be formed at the peaks 22 to further assist in providing the vacuum. As described below, the vacuum ports 26 assist in drawing the infill material 100 onto the mold surface 16 to define the surface pattern 20 along the infill material 100.

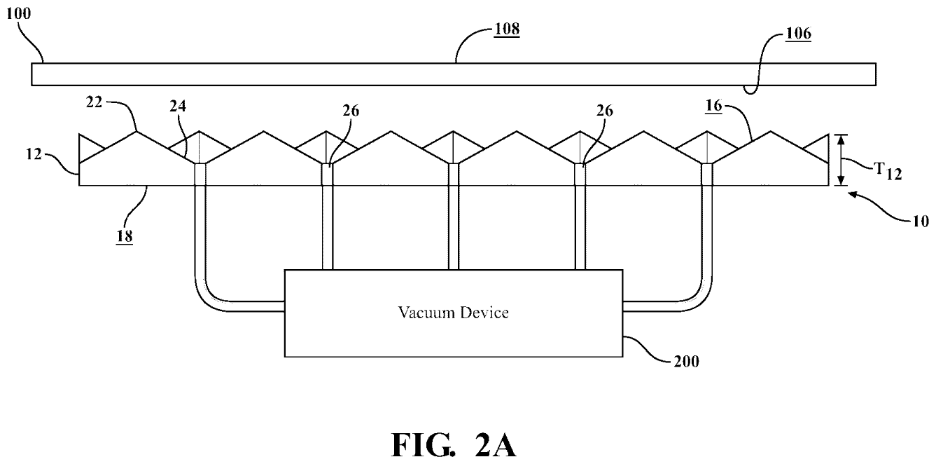

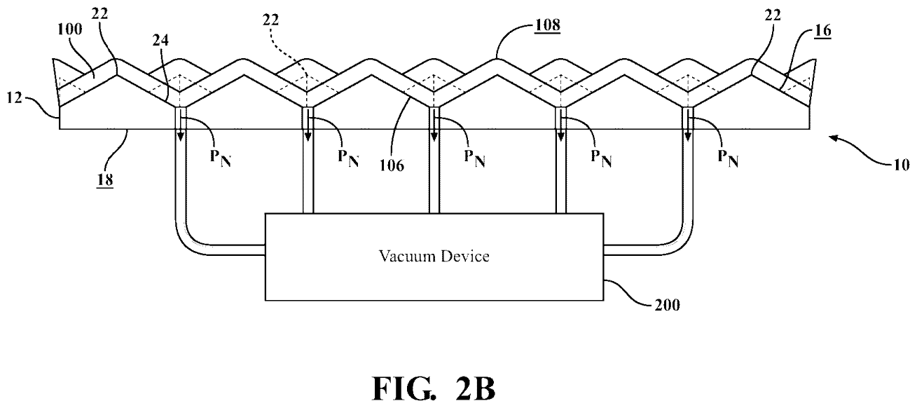

Referring to FIGS. 1-2B, the infill material 100 is disposed on the base mold 12. The infill material 100 has a first surface 106 and a second surface 108 disposed on an opposite side of the infill material 100 than the first surface 106. In one configuration, the first surface 106 may be disposed on the mold surface 16 during formation. The infill material 100 may be an ethylene-vinyl acetate (EVA) foam able to be molded or otherwise shaped into a specified configuration. For example, the infill material 100 may take the shape of the surface pattern 20 of the mold surface 16.

EVA foam is pliable and responds to applied pressure and heat. As such, the infill material 100 and the base mold 12 may utilize thermoforming techniques in addition to the applied negative pressure P_{N}. During thermoforming, heat may be applied to one or both of the infill material 100 and the base mold 12 to mold the infill material 100 along the mold surface 16. The infill material 100 may thus be thermoformed with the base mold 12 to define the textured exterior surface 104 of the infill 102.

Thermoforming typically involves applying heat to a surface, such as the first or second surfaces 106, 108 of the infill material 100 and/or the mold surface 16. The heat increases the pliability of the infill material 100, which helps to mold or otherwise shape the infill material 100 into a desired form. In some configurations, heat may be applied along the mold surface 16 to subsequently heat the first surface 106 of the infill material 100. It is contemplated that heating both the infill material 100 and the mold surface 16 may maximize the definition and formation of the surface pattern 20 along the infill material 100, such that the second surface 108 may at least partially begin to define the surface pattern 20, as described further below.

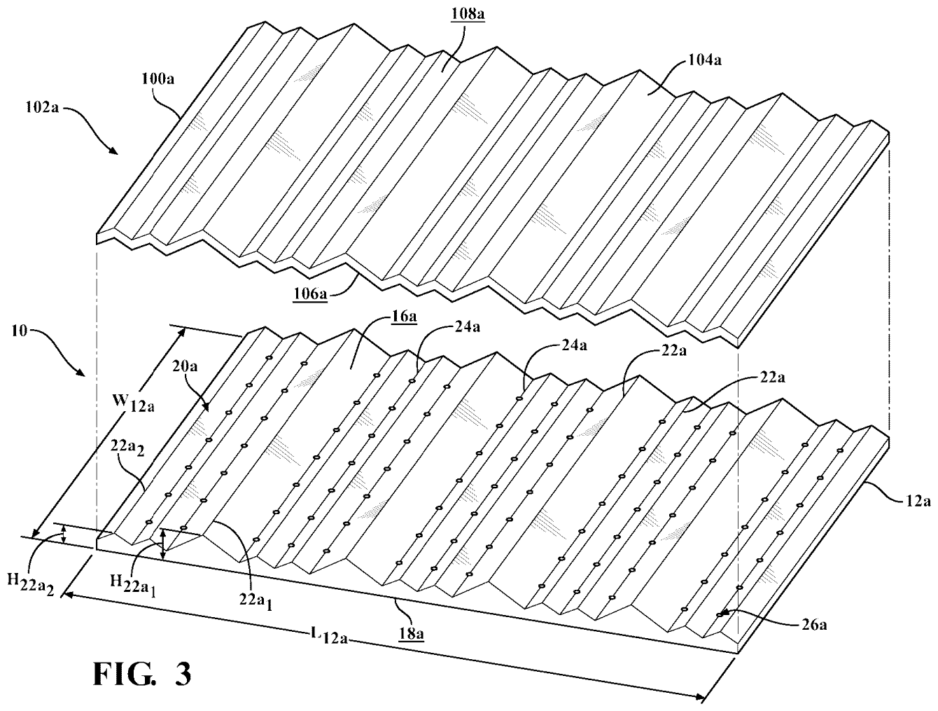

With reference to FIGS. 3-5, an example of a base mold 12a for the mold system 10 according to the present disclosure is shown. The base mold 12a has substantially similar construction to the base mold 12 discussed with respect to FIGS. 1-2B, except that a surface pattern 20a of the base mold 12a is different than the surface pattern 20 discussed previously.

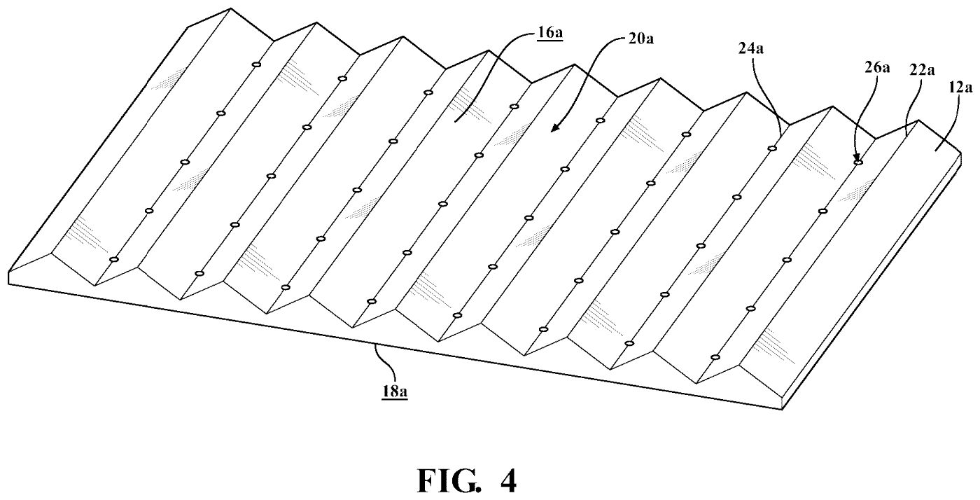

The base mold 12a includes a mold surface 16a formed on a first side of the base mold 12a and a base surface 18a formed on an opposite side of the base mold 12a than the mold surface 16a. The base surface 18a of the base mold 12a has a substantially flat profile as compared to the mold surface 16a of the base mold 12a. The mold surface 16a may define a textured profile including the desired surface pattern 20a to be formed on an exterior surface 104a of an infill 102a. Here, the surface pattern 20a includes a plurality of peaks 22a and recesses 24a that alternate along the mold surface 16a to form a wave pattern along the mold surface 16a. For example, a length L₁₂ₐ of the base mold 12a may have a wave profile with the peaks 22a and the recesses 24a clearly visible. Comparatively, a width W₁₂ₐ of the base mold 12a may have a linear profile such that a single peak 22a may be visible or only a first peak 22a₁ and a second peak 22a₂ may be visible. As depicted in FIG. 3, the peaks 22a may have varying heights. For example, the first peak 22a₁may have a height H₂₂ₐ₁ that is greater than a height H₂₂ₐ₂ of the second peak 22a₂, which may define the surface pattern 20a along the length L₁₂ₐ of the base mold 12a. Additionally or alternatively, the peaks 22a may have a consistent height along a length of the mold surface 16a, as depicted in FIG. 4.

As with the base mold 12, the base mold 12a also includes a plurality of vacuum ports 26a extending through a thickness of the base mold 12a from the base surface 18a. Thus, a negative pressure P_{N} provided to the base mold 12a by a vacuum device 200 is communicated through the vacuum ports 26a to the mold surface 16a. For example, the vacuum ports 26a may extend through the recesses 24a and assist in applying the negative pressure P_{N} along the mold surface 16a of the base mold 12a.

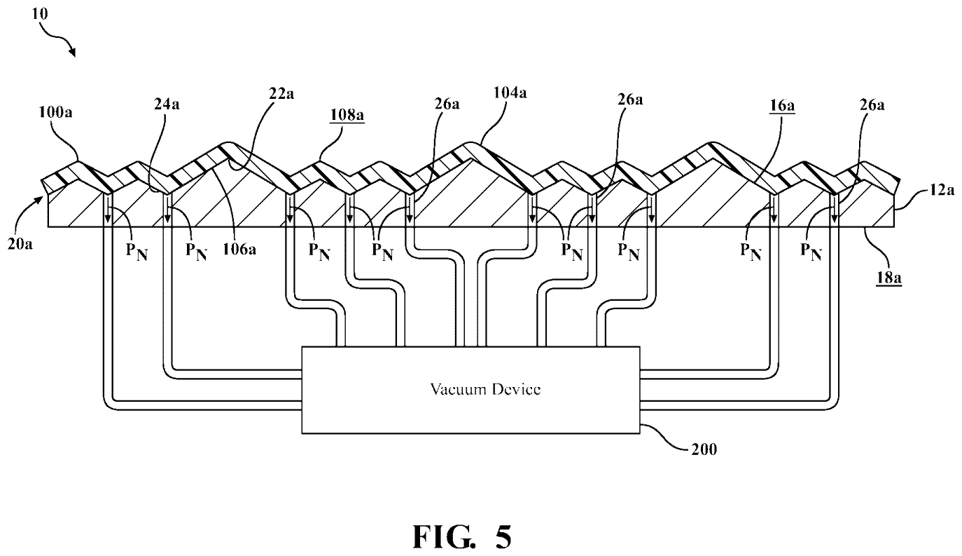

In operation, an infill material 100a is disposed on the mold surface 16a of the base mold 12a. The infill material 100a has a first surface 106a and a second surface 108a formed on an opposite side of the infill material 100a than the first surface 106a. Like the infill material 100, the infill material 100a is drawn onto the base mold 12a via the negative pressure P_{N} applied through the vacuum ports 26a. For example, the first surface 106a is engaged with the mold surface 16a in response to the applied negative pressure P_{N}, as depicted in FIG. 5.

With reference again to FIGS. 2A and 2B, an elevational view of the mold system 10 shows the infill material 100 disposed on the mold surface 16 of the base mold 12. While the mold system 10 is shown with the base mold 12 in FIGS. 2A and 2B, it will be appreciated that the example of the base mold 12a may be used with the mold system 10. The base mold 12 is operably coupled to a vacuum device 200 that is configured to provide the negative pressure P_{N} along the mold surface 16 of the base mold 12. The negative pressure P_{N} is provided by the vacuum device 200 through the vacuum ports 26 of the base mold 12 to the first surface 106 of the infill material 100. The negative pressure P_{N} is provided along the mold surface 16 to draw the infill material 100 into the recesses 24 of the mold surface 16. As mentioned above, the infill material 100 and/or the base mold 12 may be heated, such that the infill material 100 may be thermoformed with the base mold 12, while the negative pressure P_{N} is applied. The heated infill material 100 has an increased degree of pliability, which allows the negative pressure P_{N} to draw the infill material 100 downward and into engagement with the surface pattern 20 of the mold surface 16. Engagement between the infill material 100 and the surface pattern 20 of the mold surface 16 causes the infill material 100 to take the shape of the surface pattern 20, thereby providing the resulting infill 102 with the surface pattern 20.

As the infill material 100 cools along the base mold 12, the infill material 100 sets into the surface pattern 20 of the mold surface 16 to form the textured exterior surface 104 of the infill 102. It is contemplated that the surface pattern 20 may be more clearly defined along the first surface 106 of the infill material 100 as compared to the second surface 108 due to the direct contact between the first surface 106 and the mold surface 16 of the base mold 12. Specifically, while the applied negative pressure P_{N} draws the entirety of the infill material 100 toward the base mold 12, the direct contact between the first surface 106 and the base mold 12 may result in greater definition along the first surface 106 of the infill material 100 as compared to the second surface 108.

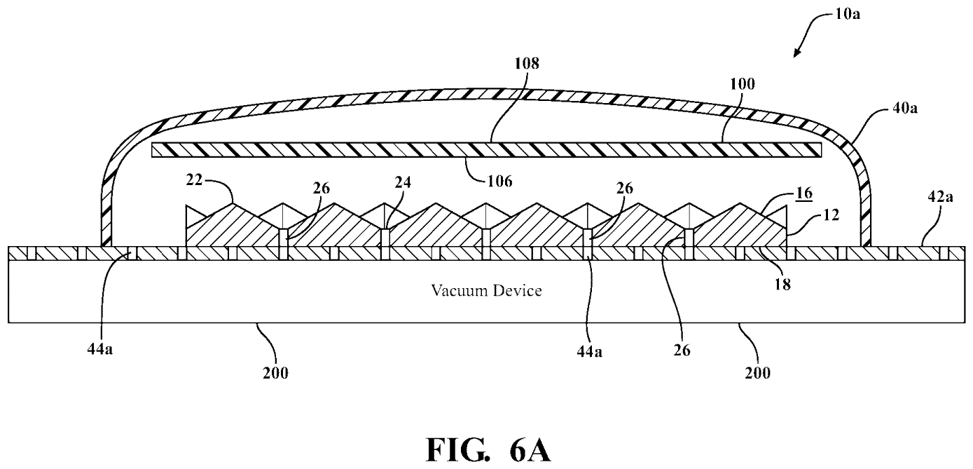

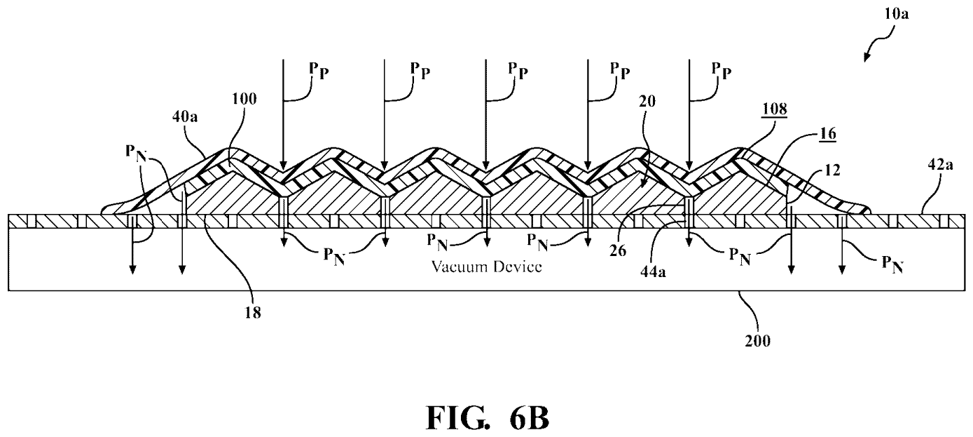

With reference now to FIGS. 1, 6A, and 6B, an example of a mold system 10a according to the present disclosure is shown. While either of the base molds 12, 12a described herein may be utilized with the mold system 10a, here the mold system 10a is illustrated with the base mold 12 and infill material 100 to ultimately mold the infill 102. The mold system 10a includes a flexible sheet 40a disposed over the base mold 12 and the infill material 100. By way of example, not limitation, the flexible sheet 40a may be formed from a silicone material, which may be flexibly disposed along the base mold 12 to conform to the surface pattern 20. For example, the flexible sheet 40a is pliable relative to the base mold 12 to optionally take the shape of the base mold 12, including the surface pattern 20, as described below. The flexible sheet 40a is coupled to a vacuum surface 42a on which the base mold 12 is disposed. The vacuum surface 42a includes a plurality of vacuum ports 44a in fluid communication with the vacuum ports 26 formed through the base mold 12. The negative pressure P_{N} is provided by the vacuum device 200 through the vacuum ports 44a of the vacuum surface 42a to the mold surface 16 of the base mold 12 via the vacuum ports 26.

The flexible sheet 40a is disposed over both the base mold 12 and at least a portion of the vacuum surface 42a, such that the negative pressure P_{N} provided through the vacuum ports 44a of the vacuum surface 42a is also applied to the flexible sheet 40a. The flexible sheet 40a is drawn toward the base mold 12, described further below, in response to the negative pressure P_{N}. The flexible sheet 40a applies a positive pressure P_{P} along the second surface 108 of the infill material 100 and generally compresses the infill material 100 between the flexible sheet 40a and the base mold 12.

As mentioned above, heat may be applied to the infill material 100 to assist in molding the infill material 100 with the mold surface 16. For example, a thermoforming process may be used, at least in part, to mold the infill material 100 by increasing the pliability of the infill material 100. The mold system 10a is in fluid communication with the vacuum device 200, which provides the negative pressure P_{N} to the base mold 12 and the infill material 100 through the vacuum ports 26, 44a. The vacuum device 200 applies the negative pressure P_{N} to the first surface 106 of the infill material 100, which draws the infill material 100 into contact with the surface pattern 20 of the mold surface 16 of the base mold 12. The negative pressure P_{N} also draws the flexible sheet 40a toward the infill material 100, and the flexible sheet 40a applies a positive pressure P_{P} along the second surface 108 of the infill material 100 to compress the infill material 100 along the mold surface 16. Thus, with the mold system 10a, the infill material 100 may have both the positive pressure P_{P} and the negative pressure P_{N} applied during the molding process.

Stated differently, the molding of the infill material 100 with the mold system 10a is in part due to the vacuum device 200 removing air from between the base mold 12 and the flexible sheet 40a. The negative pressure P_{N} applied to the flexible sheet 40a results in the flexible sheet 40a applying the positive pressure P_{P} to the infill material 100. The flexible sheet 40a generally takes the form of the base mold 12, as the flexible sheet 40a is compressed around the base mold 12. The infill material 100 is thus directly molded with the surface pattern 20 of the base mold 12 on both the first surface 106 and the second surface 108 as a result of the compression of the flexible sheet 40a. Stated differently, the mold surface 16 forms the surface pattern 20 along the first surface 106 of the infill material 100 in response to the negative pressure P_{N} from the vacuum device 200, and the flexible sheet 40a forms the surface pattern 20 along the second surface 108 of the infill material 100 by applying the positive pressure P_{P} to the second surface 108. This configuration results in the infill material 100 being compressed between the base mold 12 and the flexible sheet 40a due to the infill material 100 and the flexible sheet 40a being subjected to a vacuum (i.e., negative pressure P_{N}). The negative pressure P_{N} and the flexible sheet 40a may be applied to the infill material 100 for a predetermined time to set the surface pattern 20 and to mold the infill 102. After the predetermined period of time, the flexible sheet 40a may be removed from the base mold 12, and the formed infill 102 may be removed.

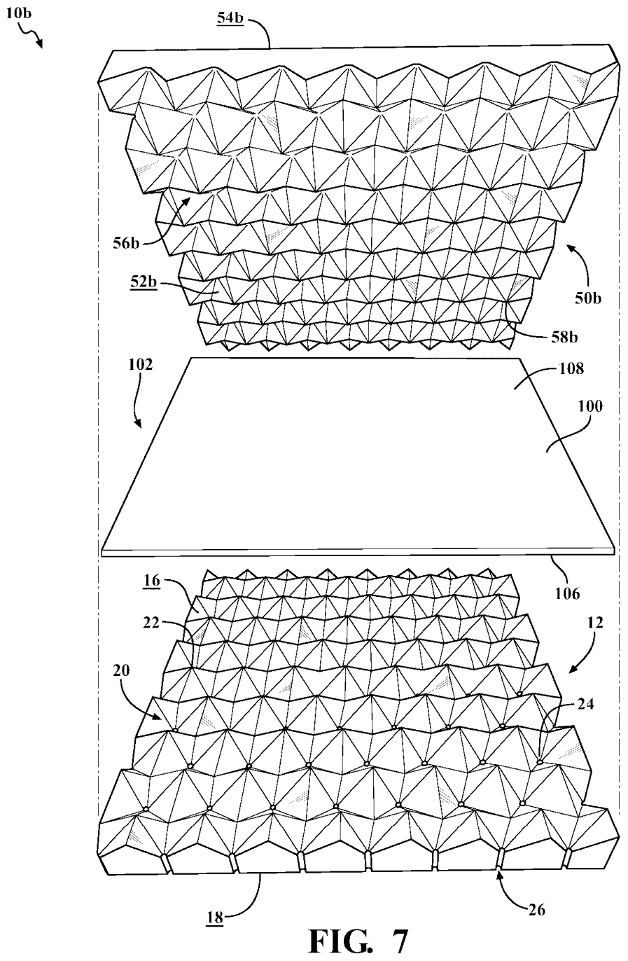

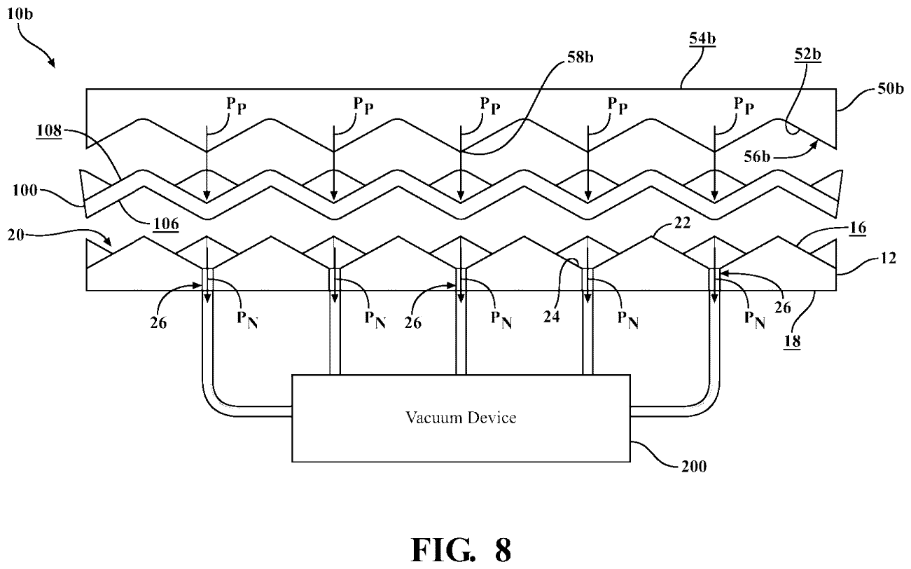

With particular reference to FIGS. 7 and 8, a mold system 10b is provided. While the mold system 10b may include either of the base molds 12, 12a described herein, the mold system 10b is illustrated with the base mold 12 to mold the infill 102. The mold system 10b includes the base mold 12 and a second, top mold 50b that is configured to be disposed on the base mold 12. The top mold 50b includes a mating surface 52b and a base surface 54b formed on an opposite side of the top mold 50b from the mating surface 52b. The mating surface 52b has a mating pattern 56b that is configured to mate with the surface pattern 20 of the base mold 12. For example, the top mold 50b is configured to nest with the base mold 12, with peaks 58b of the top mold 50b nesting within the recesses 24 of the base mold 12.

The infill material 100 may be positioned on the base mold 12, such that the first surface 106 is in contact with the mold surface 16 of the base mold 12. The top mold 50b is positioned on the second surface 108 of the infill material 100 to apply a positive pressure P_{P} along the second surface 108 of the infill material 100. Heat may be applied to the base mold 12 and/or the top mold 50b to increase the pliability of the infill material 100 along both the first and second surfaces 106, 108. As discussed previously, the infill material 100 may be thermoformed, at least in part, such that as heat is applied to the base mold 12 and the infill material 100, the infill material 100 may retreat into the recesses 24 of the mold surface 16. Heat may also be applied to the top mold 50b as the top mold 50b is applied to the second surface 108 of the infill material 100. The positive pressure P_{P} applied by the top mold 50b further defines the surface pattern 20 of the mold surface 16 by compressing the infill material 100 along the mold surface 16, while also defining the mating pattern 56b of the mating surface 52b. For example, the top mold 50b is compressed along the second surface 108 of the infill material 100, such that the mating pattern 56b formed along the mating surface 52b is compressed and formed along the second surface 108 of the infill material 100. The top mold 50b may be compressed via a clamp or other known compression devices to apply the positive pressure P_{P} along the infill material 100.

The base mold 12 is in fluid communication with the vacuum device 200, which provides the negative pressure P_{N} to the mold surface 16. The negative pressure P_{N} assists in drawing the infill material 100 into the recesses 24 of the base mold 12, while the top mold 50b applies the positive pressure P_{P} along the second surface 108 of the infill material 100. After a predetermined period of time, the top mold 50b may be removed from the infill material 100 and the base mold 12, and the formed infill 102 may be removed from the base mold 12.

Referring again to FIGS. 6A and 6B, a method of molding an infill material 100 using the example mold system 10a is provided. While the mold system 10a is shown as the example, it will be appreciated that any one of the examples of mold systems 10-10b may be used. In one step, a base mold 12 is formed. The base mold 12 includes a base surface 18 and a mold surface 16 formed on an opposite side of the base surface 18. The base mold 12 also includes a plurality of vacuum ports 26 extending between the base surface 18 and the mold surface 16. An infill material 100 is positioned along the mold surface 16. The infill material 100 includes a first surface 106 in contact with the mold surface 16 and a second surface 108 formed on an opposite side of the infill material 100 than the first surface 106. In another step, heat is applied to the second surface 108 of the infill material 100.

With specific reference to FIG. 6B, a vacuum is applied through the vacuum ports 26 of the base mold 12 to the first surface 106 of the infill material 100. The applied vacuum draws the infill material 100 into contact with the mold surface 16. Optionally, a positive pressure P_{P} is applied along the second surface 108 of the infill material to form a molded infill 102. A flexible sheet 40a may be provided and disposed over the base mold 12 and the infill material 100. The positive pressure P_{P} is applied by compressing the flexible sheet 40a along the second surface 108 of the infill material 100 via the vacuum.

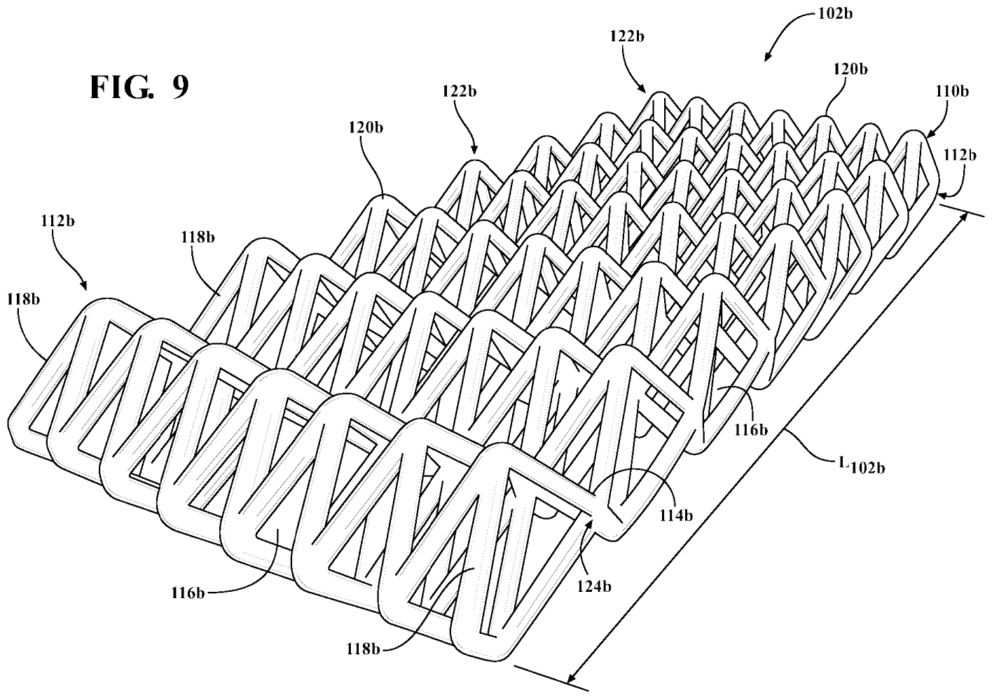

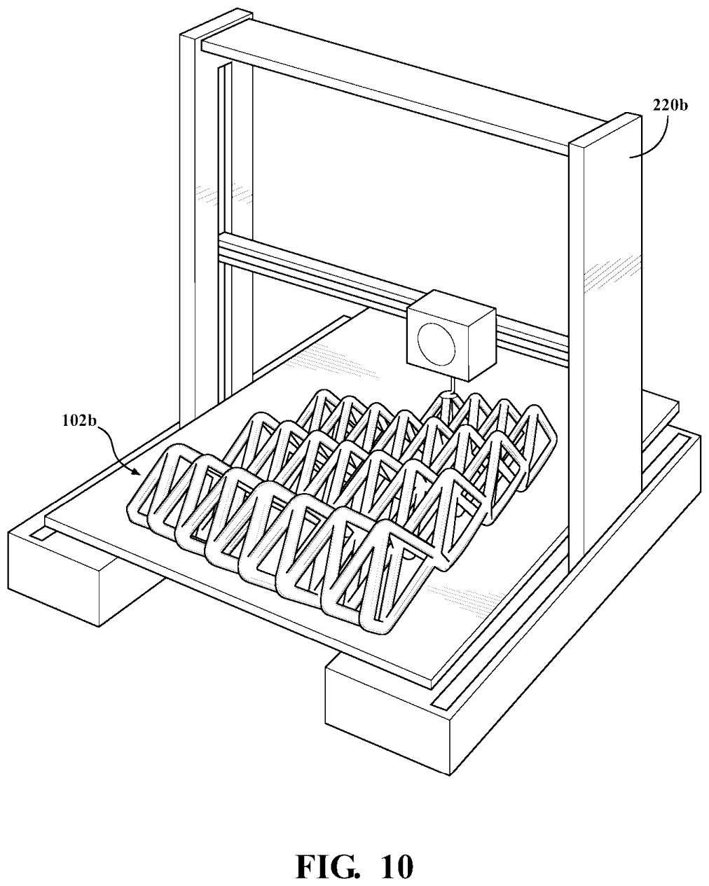

With particular reference to FIGS. 9-12, another example of an infill 102b is provided. The infill 102b is illustrated as a skeletal structure having a waveform defined along a length L_{102b}of the infill 102b. The infill 102b may be printed or otherwise defined using additive manufacturing including, but not limited to, shape deposition manufacturing (SDM), during which the infill 102b is formed using a progressive build of material to form the infill 102b. It is also contemplated that the infill 102b may be formed using selective laser sintering (SLS), rapid prototyping, and/or computer numerical control machining, which may utilize automated high-speed cutting tools to form the waveform of the infill 102b. By way of example, not limitation, the additive manufacturing may be executed using a three-dimensional (3D) printer 220b, depicted in FIG. 10, such that the infill material may be printed using a polymer material by the progressive building of the polymer material.

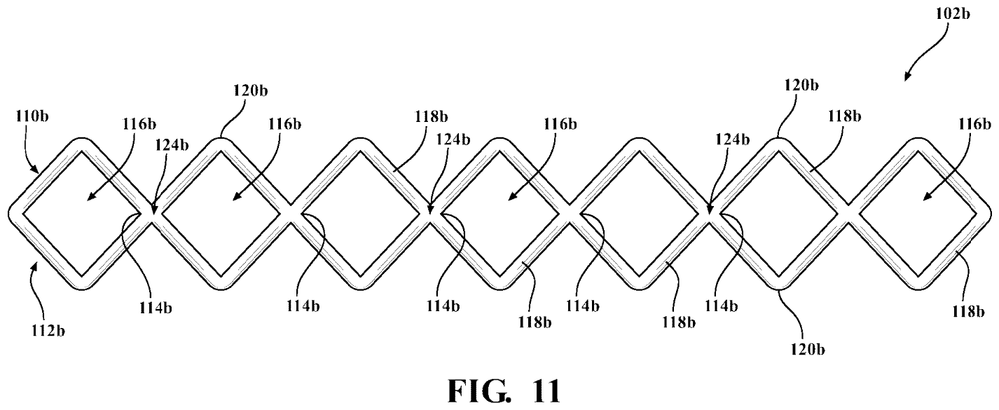

The infill 102b may be formed having multiple layers, such that a first layer 110b may be formed using additive manufacturing separate from a second layer 112b, also formed using additive manufacturing. The first layer 110b may be welded with the second layer 112b to form the infill 102b. For example, depressions 114b defined along the first layer 110b may be welded with the peaks 120b formed along the second layer 112b to form the infill 102b. As depicted in FIG. 11, the peaks 120b of the second layer 112b are coupled to the depressions 114b of the first layer 110b at an attachment region 122b. As mentioned above, the first and second layers 110b, 112b may be welded or otherwise attached to form the infill 102b. By way of example, not limitation, radiofrequency (RF) welding may be utilized to couple the first and second layers 110b, 112b at the attachment regions 122b. The infill 102b is generally hollow, such that the first layer 110b and the second layer 112b generally form a frame of the infill 102b while also including a plurality of reliefs 116b defined between the a plurality of ribs 118b. The ribs 118b generally form the peaks 120b and the depressions 114b, and the reliefs 116b are defined between each of the ribs 118b.

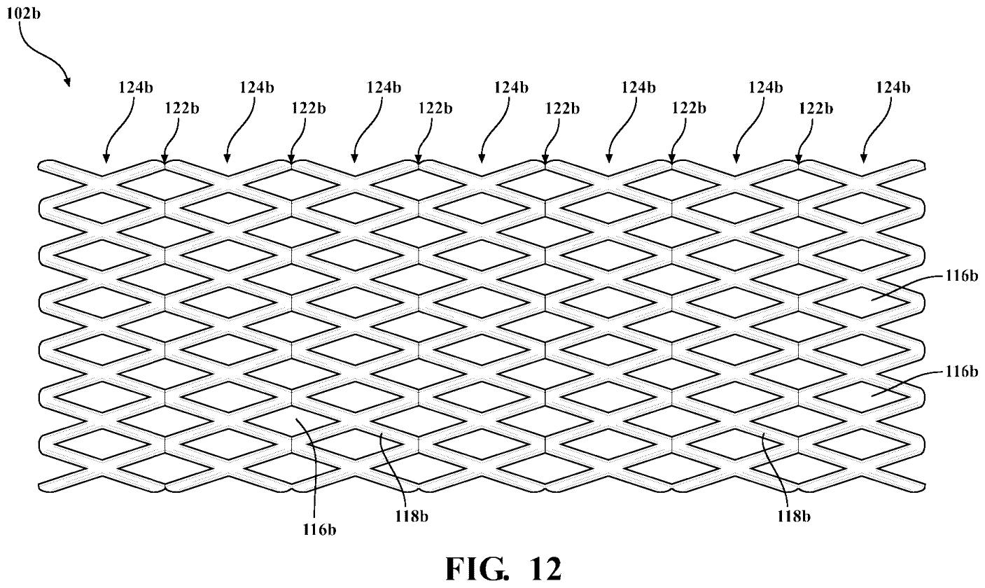

As depicted in FIG. 9, the infill 102b generally forms a lattice structure, such that the reliefs 116b form openings defined throughout the lattice structure of the infill 102b. While described herein as including a first layer 110b and a second layer 112b, it is contemplated that the infill 102b may be configured from any number of layers that may be welded or otherwise coupled to one another to form the infill 102b. It is further contemplated that the infill 102b may be formed from a plurality of rows 124b that may each be coupled together via RF welding or other practical method of attachment. For example, FIG. 12 illustrates the plurality of rows 124b coupled at the attachment regions 122b to form the infill 102b. As depicted in FIG. 12, the attachment regions 122b are defined along a width W_{102b} of the infill 102b. The attachment regions 122b may also be defined between the depressions 114b of the first and second layers 110b, 112b in combination with being defined between each row 124b along the width W_{102b} of the infill 102b.

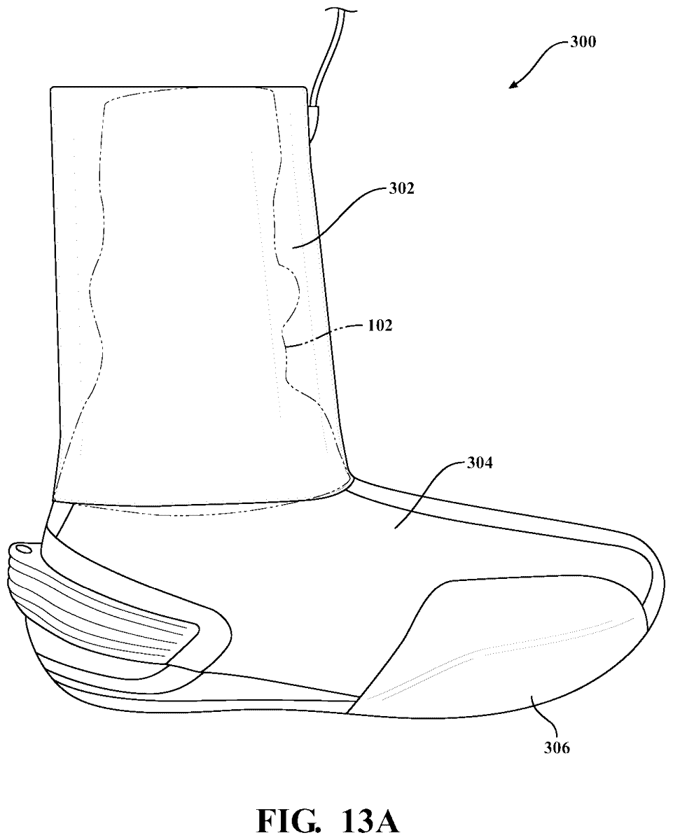

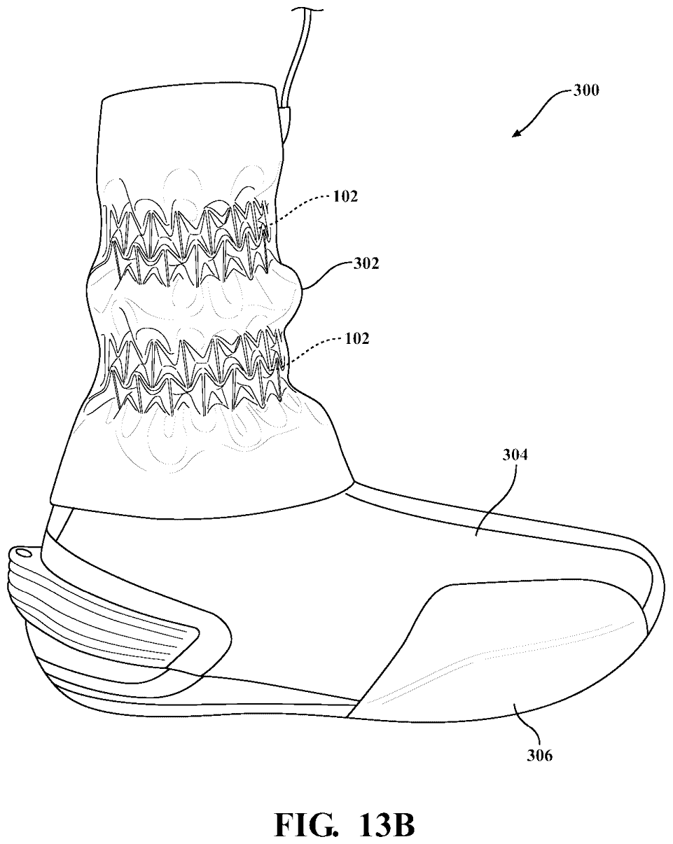

FIGS. 13A and 13B show an example of an article of footwear 300 including the infill 102 disposed within a throat 302 of the footwear 300. However, the principles of the present disclosure may be used for forming infills used in other parts of the article of footwear 300, such as in an upper 304 or a sole structure 306 of the article of footwear 300. The principles of the present disclosure may also be used for forming infills used in other articles including, but not limited to, articles of apparel. Although illustrated with the infill 102, it is contemplated that any of the infills 102-102b may be used with the footwear 300.

In FIGS. 13A and 13B, the infill 102 is received within a bladder. The bladder may be formed from two opposing sheets of pliable material such as, for example, thermoplastic polyurethane (TPU). The sheets of material may be joined together at an outer periphery of the sheets to define an interior void. The infill 102 may be received within the interior void between the first sheet and the second sheet.

In operation, when the bladder is at atmospheric pressure (FIG. 13A), the bladder is at rest and the infill 102 is in an expanded state. When fluid is removed from the interior void of the bladder, the sheets are moved toward one another and the infill 102 is compressed (FIG. 13B). Compression of the infill 102 causes both the material forming the infill 102 to compress and causes the structure of the infill 102 to compress. The structure of the infill 102 is generally designed to compress in a controlled manner based on the shape of the infill 102. For example, the infill 102—when subjected to vacuum within the interior void of the bladder—will respond by contracting with each recesses becoming smaller and each peak moving closer to an adjacent peak. A similar situation would occur with respect to a bladder including the infill 100a, which would likewise have adjacent peaks move toward one another during compression, thereby causing an overall length of the infill 100a to be reduced (i.e., as each recess is reduced and adjacent peaks move toward one another). In so doing, the bladder and infill 102 cooperate to constrict around the wearer when fluid is removed from the interior void to help retain the article in a desired position relative to the wearer.

When the vacuum is released and fluid is permitted to return to the interior void of the bladder, the infill 102 automatically returns to the expanded state from the constricted state due to the shape of the infill 102 and the resilient nature of the material forming the infill 102. As such, the bladder is returned to the relaxed state and the article is no longer constricted about the wearer.

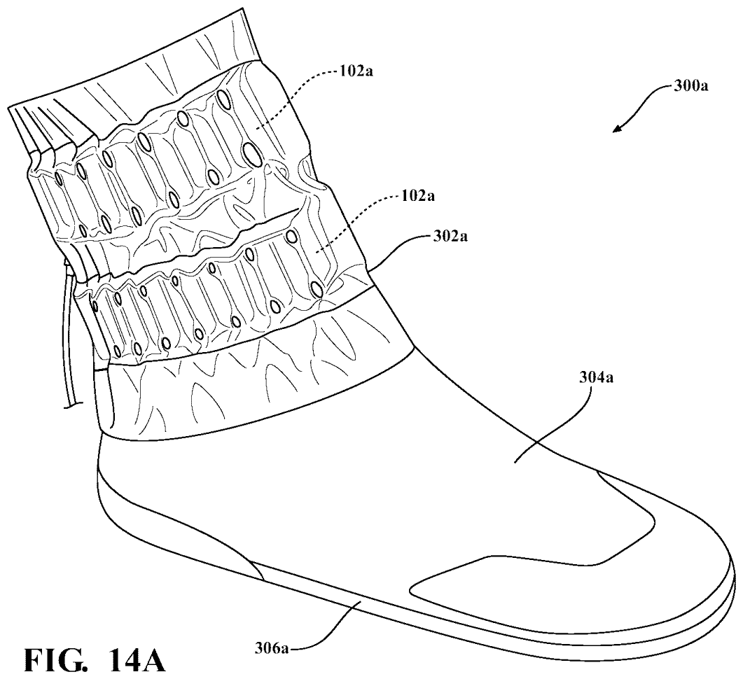

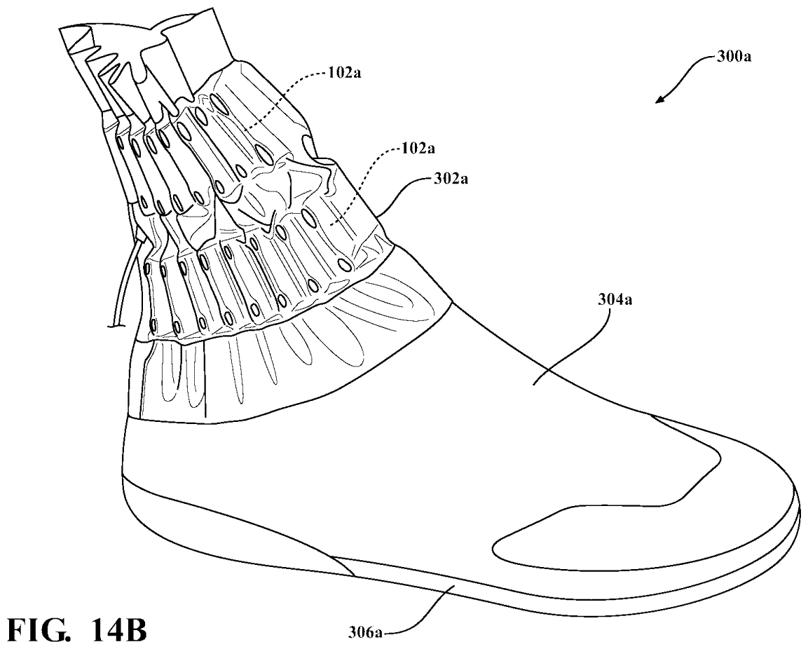

FIGS. 14A and 14B show another example of an article of footwear 300a including the infill 102a disposed within a throat 302a of the footwear 300a. However, the principles of the present disclosure may be used for forming infills used in other parts of the article of footwear 300a, such as in an upper 304a or a sole structure 306a of the article of footwear 300a. The principles of the present disclosure may also be used for forming infills used in other articles including, but not limited to, articles of apparel. Although illustrated with the infill 102a, it is contemplated that any of the infills 102-102b may be used with the footwear 300. The infill 102a is received within an interior void of a bladder in a similar fashion as the infill 102 described above with respect to FIGS. 13A and 13B. As such, the infill 102a operates in a similar fashion as the infill 102 when fluid is removed from the interior void in an effort to constrict the bladder around a wearer and retain a desired position of the bladder relative to the wearer.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method comprising:
forming a base mold including a base surface, a mold surface formed on an opposite side of the base mold, and a plurality of vacuum ports extending between the base mold and the mold surface;
positioning an infill material on the base mold, the infill material including a first surface in contact with the mold surface and a second surface formed on an opposite side of the infill material than the first surface;
applying a vacuum through the plurality of vacuum ports and to the first surface of the infill material to draw the infill material into contact with the mold surface; and
inserting the infill material into an interior void of a bladder.

2. The method of claim 1, further comprising providing a top mold including a mating surface that mates with the mold surface.

3. The method of claim 2, further comprising compressing the top mold onto the second surface of the infill material.

4. The method of claim 1, further comprising providing a flexible sheet disposed over the base mold and the infill material.

5. The method of claim 4, further comprising applying a positive pressure along the second surface by compressing the flexible sheet along the second surface via the applied vacuum.

6. The method of claim 4, wherein applying a vacuum includes positioning the base mold and the flexible sheet along a vacuum surface.

7. The method of claim 6, wherein applying a vacuum includes applying a negative pressure to the flexible sheet via vacuum ports of the vacuum surface.

8. The method of claim 1, further comprising applying heat to the base mold and/or the infill material.

9. The method of claim 1, wherein forming a base mold includes providing the mold surface with a series of peaks and recesses.

10. The method of claim 1, further comprising applying a positive pressure along the second surface of the infill material to form a molded infill.

11. A method comprising:
forming a base mold including a base surface and a mold surface formed on an opposite side of the base mold than the base surface;
positioning an infill material on the base mold, the infill material including a first surface in contact with the mold surface and a second surface formed on an opposite side of the infill material than the first surface;
drawing the infill material into contact with the mold surface of the base mold to shape the infill material into a shape of the mold surface and form an infill; and
inserting the infill into an interior void of a bladder.

12. The method of claim 11, further comprising applying a positive pressure along the second surface of the infill material to form the infill.

13. The method of claim 12, further comprising providing a top mold including a mating surface, the mating surface contacting the second surface of the infill material.

14. The method of claim 13, wherein providing a top mold includes forming a surface pattern along the mating surface, the surface pattern of the mating surface nesting with a surface pattern of the mold surface.

15. The method of claim 13, wherein applying a positive pressure along the second surface includes compressing the top mold onto the second surface of the infill material.

16. The method of claim 12, further comprising providing a flexible sheet disposed over the base mold and the infill material.

17. The method of claim 16, wherein drawing the infill material into contact with the mold surface includes applying a negative pressure to the first surface of the infill material.

18. The method of claim 17, further comprising applying a positive pressure along the second surface of the infill material.

19. The method of claim 11, further comprising applying heat to the base mold and/or the infill material.

20. Incorporating the infill of claim 11 into an article of footwear or an article of apparel.
